(19) United States
(12) Patent Application Publication
(10) Pub. No.: US 2014/0105633 A1
(43) Pub. Date: Apr. 17, 2014

(54) IMAGE HEATING APPARATUS

(71) Applicant: CANON KABUSHIKI KAISHA, Tokyo (JP)

(72) Inventor: Masahiro Takahashi, Kashiwa-shi (JP)

(73) Assignee: CANON KABUSHIKI KAISHA, Tokyo (JP)

(21) Appl. No.: 14/032,782

(22) Filed: Sep. 20, 2013

(30) Foreign Application Priority Data
Oct. 16, 2012 (JP) 2012-228824

(51) Int. Cl. G03G 15/20

(52) U.S. Cl. CPC G03G 15/206
USPC 399/90; 399/329

(57) ABSTRACT

A fixing belt of the invention includes a connector connected to a second end of a belt unit. A wiring line is wired from the connector of the second end so as to pass through an end supporting member and an inside of the fixing belt and to be drawn out of a first end of the fixing belt. The connector on the second end is formed into a size permitting to pass through the inside of the fixing belt in a condition connected to the belt unit.

### BACKGROUND OF THE INVENTION

1. Field of the Invention

The present invention relates to an image heating apparatus configured such that a heating member heats a recording medium through an intermediary of a belt member.

2. Description of the Related Art

Conventionally, there is widely known an image forming apparatus configured to transfer a toner image formed on an image carrier directly or through an intermediate transfer member to a recording medium and to fix the image on the recording medium by heating and pressing the recording medium by a fixing apparatus. Also as one mode of the fixing apparatus, there is known a belt heating-type fixing apparatus configured such that a pressure contact member is in pressure contact with an endless belt member supported by a heating member and forming a nip portion of a recording medium between the both members.

For instance, Japanese Patent Application Laid-open Nos. H4-204980 and H4-44075 have disclosed a belt heating-type fixing apparatus in which power feeding connectors are connected to both ends of a heater (heating member). This fixing apparatus is provided with a member in which an end support portion that non-rotationally supports the end of a film (belt member) from outside in an axial direction of the connector is formed integrally with a flange portion that abuts against the end of the film. This member is attached to a lag portion of a stay.

Japanese Patent Application Laid-open No. 2001-125408 has disclosed a fixing apparatus configured such that connectors are detachably attached so as to sandwich a heater (heating member) in a direction vertical to a rotation axial direction of a film. The connector functions also as a member detachably securing the heater to a supporting member that supports the heater, and has a diameter larger than that of the film.

By the way, a life of the belt member is short as compared to that of the heating member, the end supporting member, the support portion, and others, and the belt member has to be replaced with a new one per predetermined period or per predetermined number of heat processed sheets in the belt heating-type fixing apparatus described above. However, the flange portion becomes an obstacle in replacing the belt member of the fixing apparatus disclosed in Japanese Patent Application Laid-open Nos. H4-204980 and H4-44075, so that the integral member composing the flange portion and the support portion has to be detached in replacing the belt member. The connector must be also detached after detaching the integral member.

Meanwhile, the connector must be detached in replacing the belt member also in the fixing apparatus described in Japanese Patent Application Laid-open No. 2001-125408, so that works for replacing the belt member have become cumbersome.

### SUMMARY OF THE INVENTION

According to a first aspect of the present invention, an image heating apparatus, includes an endless rotational belt member, a first end supporting member configured to be non-rotational and to support a first end of the belt member, a second end supporting member configured to be non-rotational, to support a second end of the belt member, and to be a size permitting to pass through an inside of the belt member, a heating member having a first electrode portion projecting outside in a rotation axial direction of the belt member from the first end supporting member, and a second electrode portion projecting outside in the rotation axial direction of the belt member from the second end supporting member, the heating member being in contact with an inner surface of the belt member and heating a recording medium through an intermediary of the belt member, a first connector connected to the first electrode portion, a second connector connected to the second electrode portion and formed into a size permitting to pass through the inside of the belt member in a condition being connected with the second electrode portion, and a wiring line wired from the second connector to pass through the second end supporting member and a space of an inner circumferential side of the belt member and to be drawn out of the first end of the belt member.

According to a second aspect of the present invention, an image heating apparatus includes an endless rotational belt member, a first end supporting member configured to be non-rotational and to support a first end of the belt member, a second end supporting member configured to be non-rotational, to support a second end of the belt member, and to be a size permitting to pass through an inside of the belt member and a shift restricting member detachably attached to the second end supporting member and abutting against an edge of the second end of the belt member to restrict a shift movement of the belt member.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus.

FIG. 2 is a schematic diagram illustrating a configuration of a fixing apparatus.

FIG. 3 is a perspective view showing partially in section of the fixing apparatus.

FIGS. 4A and 4B are schematic diagrams illustrating wiring structures of comparative exemplary fixing apparatus.

FIG. 5 is a schematic diagram illustrating a wiring structure of a fixing apparatus of the first embodiment.

FIGS. 6A and 6B are schematic diagrams illustrating an end of a fixing belt in assembled conditions.

FIG. 7 is a perspective view of the end of the fixing belt in the assembled condition.

FIG. 8A is a perspective view illustrating the end of the fixing belt in a condition in which a shift restricting member is attached.

FIG. 8B is a perspective view illustrating the end of the fixing belt in a condition in which the shift restricting member is drawn out.

FIG. 9 is a perspective view illustrating works in replacing the fixing belt.

FIG. 10 is a schematic diagram illustrating a wiring structure of a fixing apparatus of a second embodiment.

### DESCRIPTION OF THE EMBODIMENTS

Embodiments of the present invention will be explained in detail below with reference to the drawings.

### <Image Forming Apparatus>

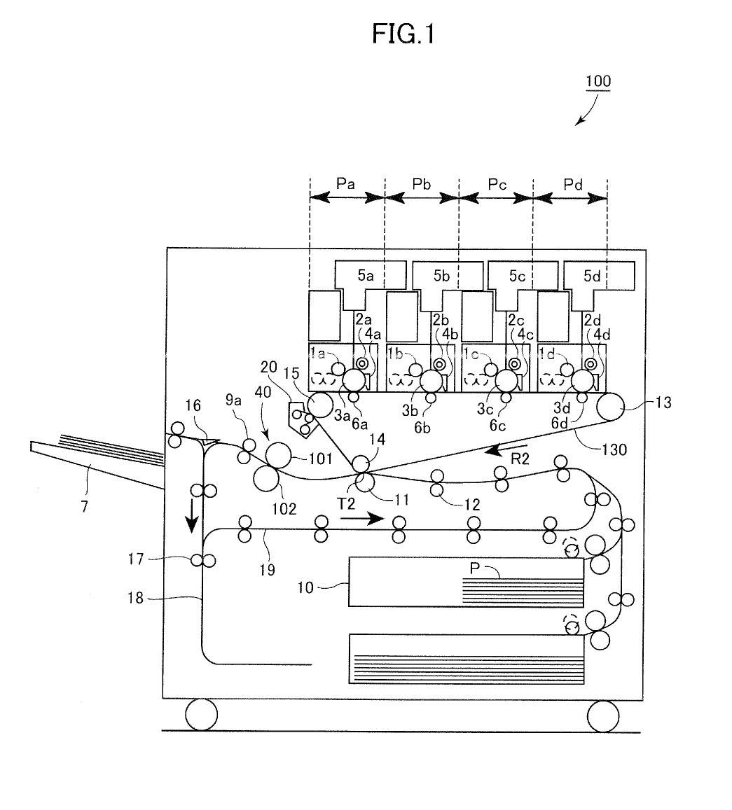

FIG. 1 is a schematic diagram illustrating a configuration of an image forming apparatus. As shown in FIG. 1, the image forming apparatus 1000 is a tandem-type intermediate transferring full-color printer in which yellow, magenta, cyan and black image forming portions Pa, Pb, Pc and Pd are arrayed along an intermediate transfer belt 130.

A yellow toner image is formed on a photoconductive drum 3a and is primarily transferred to the intermediate transfer belt 130 in the image forming portion Pa. A magenta toner image is formed on a photoconductive drum 3b and is primarily transferred to the intermediate transfer belt 130 in the image forming portion Pb. In the same manner, cyan and black toner images are formed respectively on photoconductive drums 3c and 3d and are primarily transferred to the intermediate transfer belt 130 in the image forming portions Pc and Pd.

A recording medium P is taken out of a recording medium cassette 10 one by one and stands by at a registration roller 12. The registration roller 12 feeds the recording medium P to a secondary transfer portion T2 timely with the toner images on the intermediate transfer belt 130. The recording medium P which has been conveyed to the secondary transfer portion T2 and on which the four colors of toner images have been secondarily transferred is conveyed to a fixing apparatus 40. The recording medium P is then heated and pressed by the fixing apparatus 40 such that the toner image is fixed, and is discharged to a tray 7 on an outside of the apparatus body.

In a case of a two-side printing, the recording medium P on which the toner image has been transferred to a first surface thereof and fixed by the fixing apparatus 40 is led to a reverse path 18 by a flapper 16. The recording medium P in the reverse path 18 is then led to a two-side path 19 by being reversed by a reversing roller 17. The recording medium P stands by again at the registration roller 12 and is sent to the secondary transfer portion T2 to transfer a toner image on a second surface thereof. The fixing apparatus 40 fixes the image on the second surface of the recording medium P, and the recording medium P on which the images have been fixed on both surfaces thereof is discharged to the tray 7 on the outside of the apparatus body.

The respective image forming portions Pa, Pb, Pc and Pd are configured substantially in the same manner except that colors of toners used in developers 1a, 1b, 1c and 1d are different as yellow, magenta, cyan and black. Accordingly, only the configuration of the image forming portion Pa will be explained below and an overlapped explanation of the image forming portions Pb, Pc and Pd will be omitted.

Disposed around a photoconductive drum 3a in the image forming portion Pa are a charging roller 2a, an exposure unit 5a, a developer 1a, a primary transfer roller 6a, and a drum cleaning unit 4a. The photoconductive drum 3a has a photoconductive layer formed on a surface of an aluminum cylindrical material. The charging roller 2a charges the surface of the photoconductive drum 3a with a homogeneous potential. The exposure unit 5a draws an electrostatic image of an image to be formed on the photoconductive drum 3a by scanning a laser beam. The developer 1a develops the electrostatic image and forms a toner image on the photoconductive drum 3a. The primary transfer roller 6a transfers the toner image on the photoconductive drum 3a primarily to the intermediate transfer belt 130 by being applied with a voltage.

The drum cleaning unit 4a recovers transfer remaining toner adhering on the photoconductive drum 3a without being transferred to the intermediate transfer belt 130 by scraping the photoconductive drum 3a by a cleaning blade. A belt cleaning unit 20 recovers transfer remaining toner adhering on the intermediate transfer belt 130 without being transferred to a recording medium in the secondary transfer portion T2.

### <Fixing Apparatus>

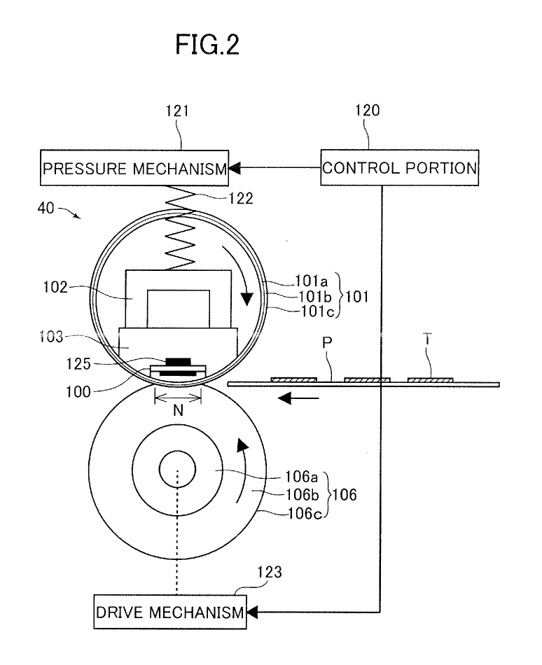

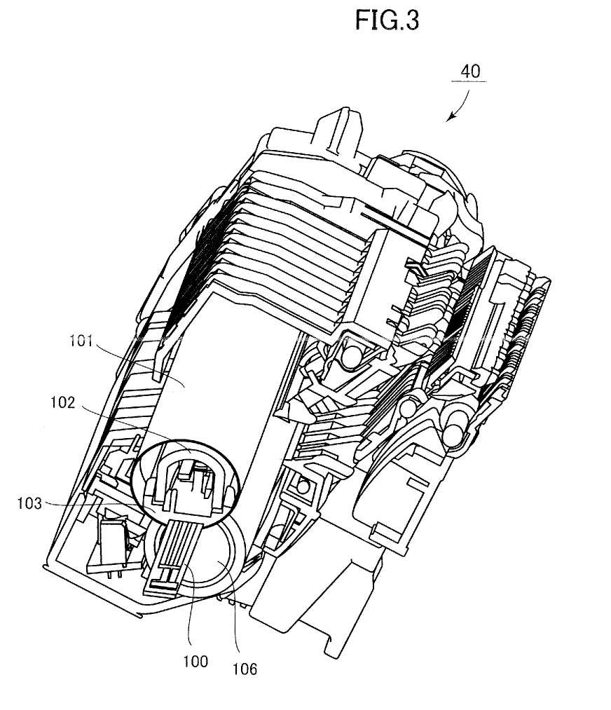

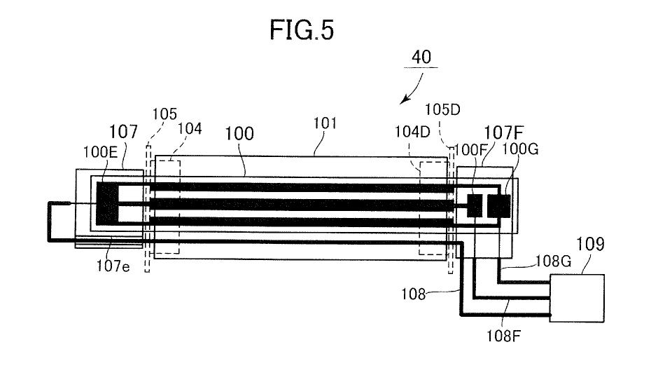

FIG. 2 is a schematic diagram illustrating a configuration of the fixing apparatus, and FIG. 3 is a perspective view showing partially in section of the fixing apparatus. As shown in FIG. 2, a guide member 103, i.e., one exemplary guide member, guides an inner surface of an endless rotational fixing belt 101 while supporting a ceramic heater 100 across an entire length in a rotation axial direction of the fixing belt 101. The fixing belt 101 also includes a stay 102, i.e., one exemplary support member, disposed to link end support members 104 and 104D (see FIG. 5) on both ends of the fixing belt 101. The stay 102 supports the guide member 103 by penetrating through the fixing belt 101 like a beam. Connectors 107F and 107 (see FIG. 5) are also configured to detachably secure the ceramic heater 100 to the guide member 103.

A pressure roller 106, i.e., one exemplary rotational member, is in pressure contact with a ceramic heater 100 through an intermediary of the fixing belt 101 and forms a nip portion N nipping a recording medium. A drive mechanism 123 rotationally drives the pressure roller 106 such that the fixing belt 101 is also rotationally driven.

The ceramic heater 100 is a ceramic substrate on which electrode patterns of electrodes 100F and 100E and a resistant heating pattern connected to these electrode patterns are formed.

The belt heating-type fixing apparatus 40 is thus configured to form the nip portion N by interposing the fixing belt 101 between the ceramic heater 100 and the pressure roller 106. The fixing apparatus 40 is configured to lead a recording medium carrying a non-fixed toner image T into the nip portion N and to pinch and convey it together with the fixing belt 101. Then, the fixing apparatus 40 fixes the non-fixed toner image T to the recording medium P by applying pressure of the nip portion N to the recording medium P while applying heat of the ceramic heater 100 through the fixing belt 101. The belt heating-type fixing apparatus is favorable from aspects of quick-starting and energy-saving performances thereof.

The fixing belt 101 is driven in synchronism with the rotation of the pressure roller 106. The fixing belt 101 is a cylindrical heat resistant belt member, i.e., an exothermic member that transmits heat to the recording medium P. The fixing belt 101 is loosely fitted around the guide member 103. The fixing belt 101 is composed of a nickel base layer 101a formed into a seamless belt of 0.04 mm in thickness and 30.0 mm in diameter by electro-casting, an elastic layer 101b made of silicon rubber and laminated on the base layer 101a, and a mold release layer 101c made of a PFA resin tube coated on a surface of the elastic layer 101b.

The pressure roller 106 is driven by the drive mechanism 123 and rotates substantially with equal circumferential speed with conveying speed of the recording medium P carrying the toner image T and conveyed from the secondary transfer portion T2 (see FIG. 1). The pressure roller 106 is composed of an axial member 106a formed by an aluminum cylindrical member of 10 mm in outer diameter and 3 mm in thickness, an elastic layer 106b made of soft silicon rubber having 64° of Asker hardness and 3 mm in thickness and formed around the axial member 106a, and a mold release layer 106c made of a PFA tube of 50 μm in thickness and coated on a surface of the elastic layer 106b. An outer diameter of the pressure roller 106 is 25 mm.

As shown in FIGS. 2 and 3, the ceramic heater 100 increases temperature thereof by heat generated by a heating resistor to which power is supplied. The ceramic heater 100 includes the heating resistor formed by printing and sintering a thick film of Ag.Pd paste on an Al₂O₃ substrate and a glass material concealing a surface of the heating resistor. The ceramic heater 100 is provided with the electrodes to which power is supplied and which are formed on both ends in a longitudinal direction of the ceramic heater 100. The ceramic heater 100 is assembled into the fixing belt 101 by being fitted into a recess formed at an under surface of the guide member 103.

The guide member 103 positions and holds the ceramic heater 100. The guide member 103 rubs an inner surface of the fixing belt 101 in the condition penetrating through the fixing belt 101 in the rotation axial direction. The guide member 103 is formed into a shape of a beam by a synthetic resin material such as liquid crystal polymer which is heat resistant, whose elastic modulus is high, whose friction coefficient is low, and whose thermal conductivity is also low.

As shown in FIG. 2, the ceramic heater 100 supported by the guide member 103 is biased toward the pressure roller 106 through the fixing belt 101 by a pressure mechanism 121. The ceramic heater 100 and the guide member 103 are biased together toward the pressure roller 106 and forms the nip portion N between the fixing belt 101 and the pressure roller 106.

The stay 102 is disposed on the inner surface side of the fixing belt 101 to assure strength of the guide member 103. The stay 102 supports the entire guide member 103 in the longitudinal direction thereof and biases the guide member 103 toward the pressure roller 106. The stay 102 is formed into a shape of a beam having a U-shape in section by a steel member of 10 mm in width×10 mm in height and 2.3 mm in thickness.

### COMPARATIVE EXAMPLES

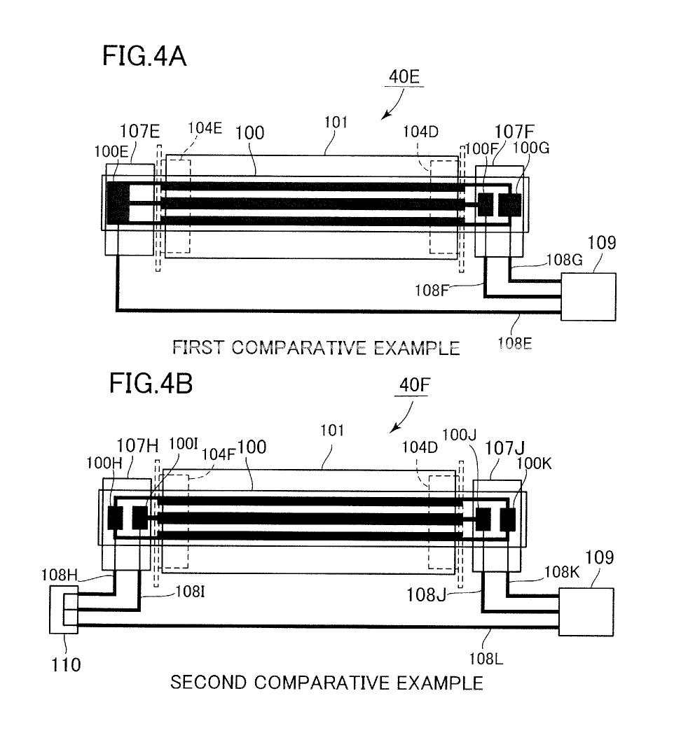

FIGS. 4A and 4B are schematic diagrams illustrating wiring structures of comparative exemplary fixing apparatuses.

As shown in FIG. 4A, the ceramic heater 100 of the first comparative example is provided with electrodes 100F and 100G formed at one end in the longitudinal direction thereof and an electrode 100E formed at another end thereof. The ceramic heater 100 is also provided with a connector 107F connected to one end thereof and with a connector 107E connected to the other end thereof. Wiring lines 108F and 108G of the connector 107F are connected to a power source 109 disposed on a side of the connector 107F of the fixing apparatus 40, and a wiring line 108E of the connector 107E is connected to the same power source 109 passing through outside of the fixing belt 101. This configuration makes it possible to heat the ceramic heater 100 by power supplied from the power source 109.

In the first comparative example, however, it is unable to replace the fixing belt 101 with new one by pulling the fixing belt 101 out of the ceramic heater 100 without pulling the connector 107E out of the electrode 100E. It is because the wiring line 108E extending from the connector 107E hinders the replacement of the fixing belt 101 which is an expendable item.

As shown in FIG. 4B illustrating the second comparative example, the ceramic heater 100 is provided with electrodes 100J and 100K formed at one end in the longitudinal direction thereof and with electrodes 100H and 100I formed at another end thereof. The ceramic heater 100 is also provided with a connector 107J connected to one end thereof and with a connector 107H connected to the other end thereof. Wiring lines 108J and 108K of the connector 107J are connected to the power source 109 disposed on a side closer to the connector 107J of the fixing apparatus 40, and wiring lines 108H and 108I of the connector 107H are connected to a wiring terminal 110 disposed on a side closer to the connector 107H of the fixing apparatus 40 to be put together as a wiring line 108L. The wiring line 108L is connected to the power source 109 passing through outside of the fixing belt 101. This configuration makes it possible to heat the ceramic heater 100 by power supplied from the power source 109.

In the second comparative example, however, it is also unable to replace the fixing belt 101 with new one by pulling the fixing belt 101 out of the ceramic heater 100 without pulling the connector 107H out of the electrodes 100H and 100I. It is because the electrodes 108H and 100I extending from the connector 107H hinder the replacement of the fixing belt 101.

Then, the fixing apparatus 40 of the following embodiment is configured such that the connector 107 connected to the end of the ceramic heater 100 is formed to be smaller than an inner diameter of the fixing belt 101 and such that the wiring line 108 passes through inside of the fixing belt 101 and is drawn out of the opposite end of the ceramic heater. This arrangement makes it possible to replace the fixing belt 101 by pulling the fixing belt 101 out of the connector 107 and the ceramic heater 100 while connecting the connectors 107 to the both ends of the ceramic heater 100.

### First Embodiment

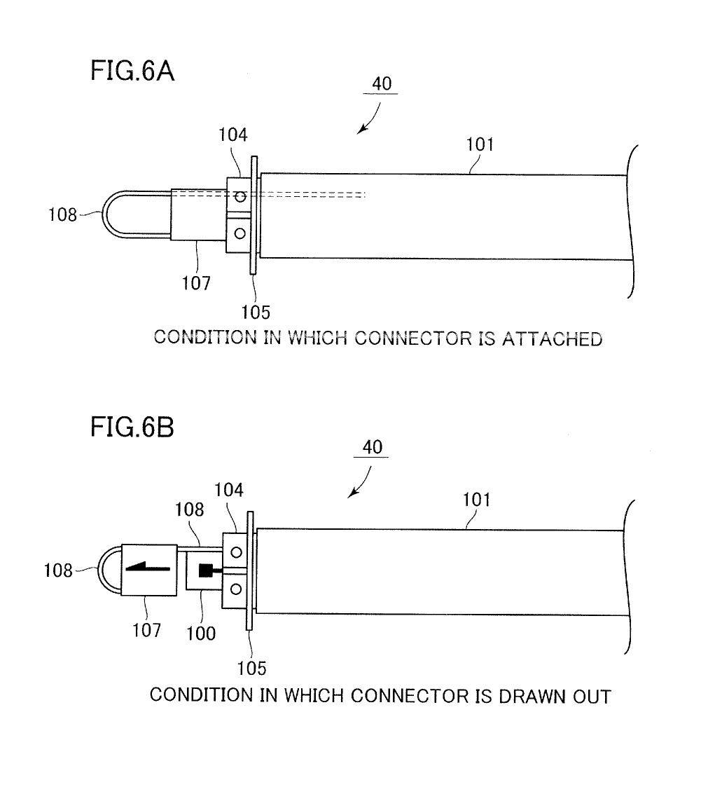

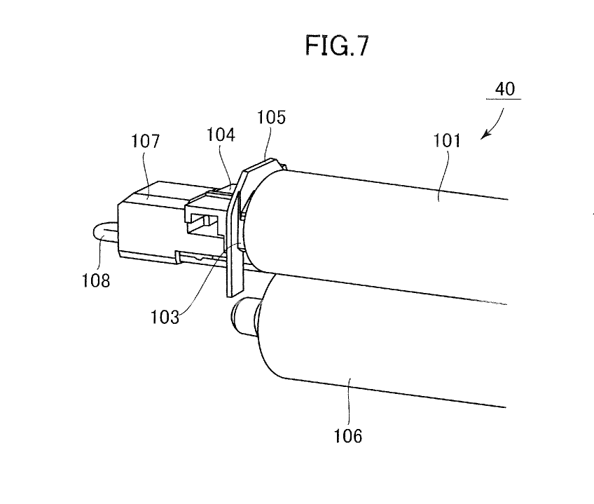

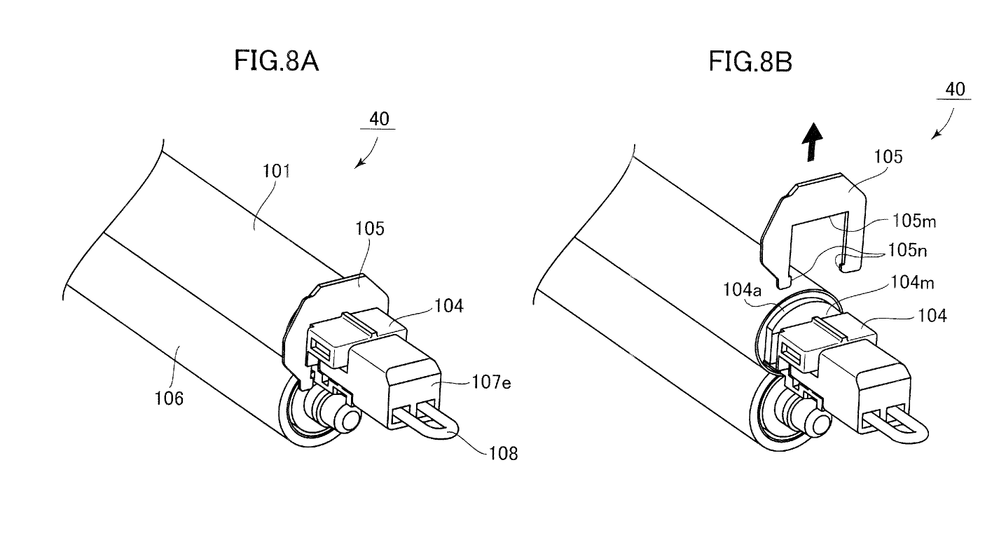

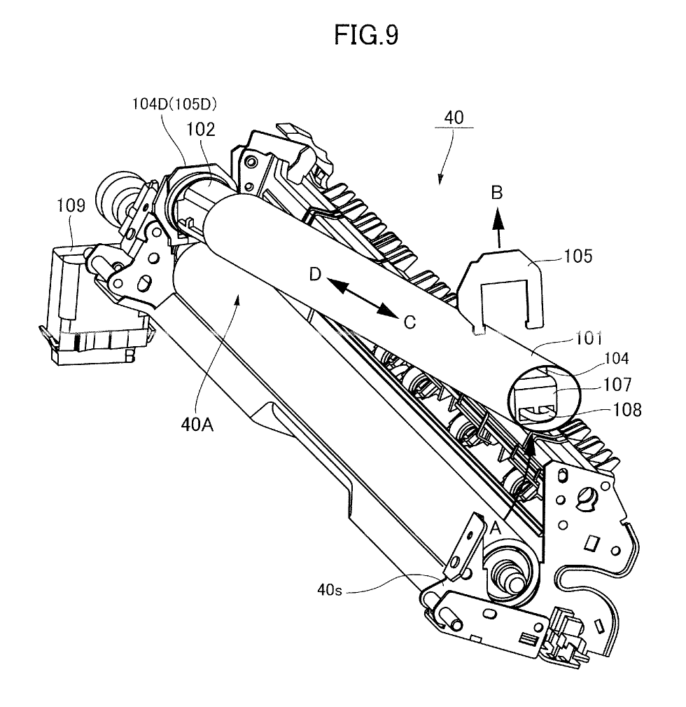

FIG. 5 is a schematic diagram illustrating a wiring structure of a fixing apparatus of the first embodiment, FIGS. 6A and 6B are schematic diagrams illustrating an end of a fixing belt in assembled conditions, FIG. 7 is a perspective view of the end of the fixing belt in the assembled condition, FIGS. 8A and 8B are perspective views partially illustrating the end of the fixing belt in conditions in which a shift restricting member is attached and detached, and FIG. 9 is a perspective view illustrating works in replacing the fixing belt.

As shown in FIG. 5, a non-rotational end supporting member 104D, i.e., one exemplary first end supporting member, supports a first end of the fixing belt 101, i.e., one exemplary endless belt member. An end supporting member 104, i.e., one exemplary second end supporting member supports a second end of the fixing belt 101. The end supporting member 104D is also provided integrally with a shift restricting portion 105D that restricts a shift movement of the fixing belt 101 by abutting against an edge of the fixing belt 101.

It is noted that although the end supporting members 104D and 104 of the present embodiment are provided to restrict a rotational orbit of the belt by being in slidable contact with an inner circumferential surface of the end of the fixing belt 101 in the present embodiment, it is not always necessary to provide them to be in slidable contact with the belt member. That is, the guide member 103 may be extended such that the guide member 103 comes in slidable contact with an inner circumferential surface of the fixing belt 101 across an entire length in an axial direction of the fixing belt 101. The both ends of the fixing belt 101 are supported by the end supporting members 104D and 104 through the stay 102 supporting the guide member 103 also in this case.

The ceramic heater 100, i.e., one exemplary heating member, is in contact with the inner surface of the fixing belt 101 and heats a recording medium through the intermediary of the fixing belt 101. The electrode 100F, i.e., one exemplary first electrode portion, of the ceramic heater 100 projects outside in the rotation axial direction of the fixing belt 101 from the end supporting member 104D. The connector 107F, i.e., one exemplary first connector, is connected to the electrode 100F.

The electrode 100E, i.e., one exemplary second electrode portion, of the ceramic heater 100 projects outside in the rotation axial direction of the fixing belt 101 from the end supporting member 104. The connector 107, i.e., one exemplary second connector, is connected to the electrode 100E. The connector 107 is configured such that it can be taken out of the electrode 100E in the rotation axial direction of the fixing belt 101. The wiring line 108, i.e., one exemplary wiring member, is wired from the connector 107 through the end supporting member 104 and the fixing belt 101. The connector 107 includes a through hole 107e configured to penetrate the wiring line 108 through the fixing belt 101 in the rotation axial direction. The through hole 107e holds the wiring line 108 movably in the rotation axial direction of the fixing belt 101.

The connector 107 is formed into a size permitting the connector 107 to pass through the inside of the fixing belt 101 while being connected with the electrode 100E. The end supporting member 104 is also formed into a size permitting the end supporting member 104 to pass through the inside of the fixing belt 101 in a body with the connector 107 connected with the electrode 100E.

As shown in FIG. 5, the connector 107 is attached to the electrode 100E on the side distant from the power source 109 among the electrodes 100E and 100F on the both ends of the ceramic heater 100 in the first embodiment.

The connector 107F on the other side is attached to the electrodes 100F and 100G on the side closer to the power source 109 among the electrodes 100E, 100F and 100G on the both ends of the ceramic heater 100.

The wiring line 108 connected to the connector 107 projects opposite the ceramic heater 100 of the connector 107. The projecting wiring line 108 is then folded back in a shape of U and is led to pass through the through hole 107e of the connector 107 and the end supporting member 104 and to penetrate through the fixing belt 101 along the stay 102 (see FIG. 2).

An edge portion of the wiring line 108 is then drawn out of the first end of the fixing belt 101 and linked up with the connector 107F on the other side. The connector 107F is connected with the power source 109 through the wiring lines 108, 108F and 108G.

As shown in FIG. 6A and as described above, the wiring line 108 is configured to be folded back in the shape of U and to penetrate through the connector 107 and the fixing belt 101.

More specifically, as shown in FIG. 6B, the U-shaped folded back portion of the wiring line 108 is extended by a length corresponding to a moving distance of the connector 107 required in pulling out the connector 107. This arrangement makes it possible to attach/detach the connector 107 to/from the ceramic heater 100 within the moving range of the connector 107 along the wiring line 108.

The U-shaped folded back wiring line 108 and the connector 107 are designed to stay within a projection range of the end supporting member 104 in the rotation axial direction of the fixing belt 101. The end supporting member 104 is designed to stay within a projection range in the rotation axial direction of the fixing belt 101 in a condition in which the shift restricting member 105 is detached.

Therefore, the U-shaped folded back wiring line 108 and the connector 107 do not hinder the fixing belt 101 from moving to the connector 107 side and from being drawn out of the ceramic heater 100.

As shown in FIG. 7, the end supporting member 104 is provided on the end of the cylindrical fixing belt 101 and guides a rotational orbit of the fixing belt 101 to be constant to suppress vibration otherwise caused by rotation of the fixing belt 101. The shift restricting member 105 is designed to extend outside of the projection range of the fixing belt 101, and abuts against an end surface of the fixing belt 101 and restricts a shift movement of the fixing belt 101 in a thrust direction heading to the connector 107.

As shown in FIG. 8A, the shift restricting member 105 is detachably attached to the end supporting member 104, and abuts against the belt edge of the fixing belt 101 and restricts the shift movement of the fixing belt 101 as described above. However, the attached shift restricting member 105 is larger than an outer diameter of the fixing belt 101, so that the shift restricting member 105 hinders the fixing belt 101 from shifting to the connector 107 side. Due to that, the shift restricting member 105 is detachably attached to the end supporting member 104 and is pulled out upward and detached out of the end supporting member 104 as shown in FIG. 8B in replacing the fixing belt 101.

As shown in FIG. 8B, the shift restricting member 105 is a plate-like member in which an inner edge 105m, i.e., one exemplary U-shaped cutaway portion, is formed. The end supporting member 104 is provided with a groove 104m, i.e., one exemplary groove, configured to hold an edge of the U-shaped inner edge 105m. That is, the shift restricting member 105 is held by the inner edge 105m inserted into the groove 104m formed on the end supporting member 104. A projection 105n at an end of the inner edge 105m engages with a recess not shown formed on the groove 104m, so that the shift restricting member 105 is secured firmly to the end supporting member 104. The projection 105n opens in attaching/detaching the shift restricting member 105 to/from the end supporting member 104, so that the projection 105n does not hinder the movement of the shift restricting member 105.

FIG. 9 illustrates a condition in which a used fixing belt 101 is removed out of the fixing apparatus 40 to replace with a new fixing belt 101.

Firstly, an end of the connector 107 side of a belt unit 40A is turned in a direction of an arrow A to take out of a side plate 40s of the fixing apparatus 40. Next, the shift restricting member 105 is detached out of the end supporting member 104 in a direction of an arrow B. Then, the fixing belt 101 is moved in a direction of an arrow C to take out of the belt unit 40A such that the fixing belt 101 slips out of the outside of the end supporting member 104 and the connector 107 being connected with each other.

Works inverse from those in removing the used fixing belt 101 are carried out in attaching a new fixing belt 101. That is, the new fixing belt 101 is inserted into the belt unit 40A from which the used fixing belt 101 has been removed and is moved in a direction of an arrow D. Next, the shift restricting member 105 is inserted into the groove of the end supporting member 104 to secure the shift restricting member 105. Then, the end of the connector 107 side of the belt unit 40A is attached to the side plate 40s of the fixing apparatus 40. This arrangement makes it possible to replace the used fixing belt 101 with new one without detaching the connector 107.

Meanwhile, the connectors 107 and 107F are detached out of the belt unit 40A after removing the fixing belt 101 out of the belt unit 40A as described above in replacing the ceramic heater 100. The connectors 107 and 107F are configured also as members that integrally restrain the guide member 103 and the ceramic heater 100, so that the ceramic heater 100 can be separated downward from the guide member 103 by detaching the connectors 107 and 107F (see FIGS. 2 and 3).

As described above, the arrangement of the first embodiment makes it possible to replace only the fixing belt 101, not the whole belt unit 40A or the fixing apparatus 40 itself, when it becomes necessary to replace the fixing belt 101 reaching its designed service life with a new one. Accordingly, it is possible to cut a cost of parts to be replaced.

The arrangement of the first embodiment makes it possible to draw out the fixing belt 101 in the rotation axial direction just by detaching the shift restricting member 105 without taking the connector 107 connected with the wiring line 108 out of the electrode 100E of the ceramic heater 100, because the shift restricting member 105 that composes a flange portion restricting the shift movement of the fixing belt 101 is detachable from the end supporting member 104.

The arrangement of the first embodiment also makes it unnecessary to pull the connector 107 out of the ceramic heater 100 in the works for replacing the fixing belt 101. Accordingly, this arrangement permits to cut man-hour in the works for replacing the fixing belt 101 and causes no contact failure of the electrode 100E that may be otherwise caused when the connector 107 is detached out of the ceramic heater 100.

The arrangement of the first embodiment also requires no electrical connecting/disconnecting works in the works for replacing the fixing belt 101. Accordingly, it is possible to prevent such failures as a defective power feed operation that may be otherwise caused by operational errors, to reduce a downtime by cutting a work time and suppressing an occurrence of abnormality, and thus to improve reliability of the fixing apparatus 40.

It is noted that the base layer 101a of the fixing belt 101 may be a stainless plate. The fixing belt 101 may be also replaced with a fixing belt including a base layer 101a of a heat resistant resin material such as polyimide formed into a seamless belt having a thickness around 0.1 mm, an elastic layer 101b made of silicon rubber and laminated on the base layer 101a, and a mold release layer 101c made of a PFA resin tube coated on a surface of the elastic layer 101b. The recording medium P may be a transfer sheet, an electrofax sheet, an electrostatic recording sheet, an OHP sheet, a printing sheet, or a format sheet.

### Second Embodiment

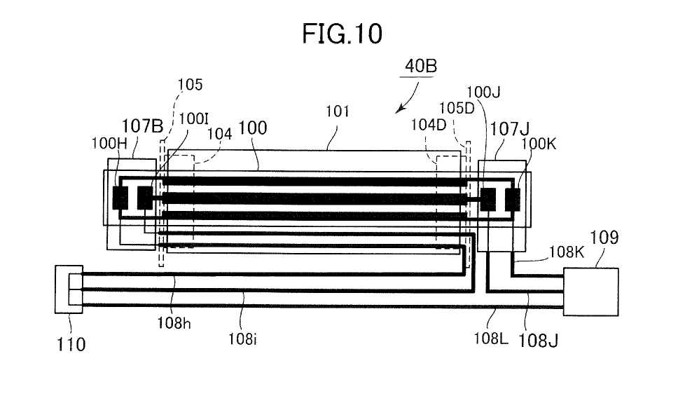

FIG. 10 is a schematic diagram illustrating a wiring structure of a fixing apparatus of a second embodiment.

As shown in FIG. 10, a connector 107B is attached to electrodes 100H and 100I on the side distant from the power source 109 among the electrodes 100H, 100I, 100J and 100K on the both ends of the ceramic heater 100 in the present embodiment.

The connector 107J on the opposite side is attached to the electrodes 100J and 100K on the side closer to the power source 109 similarly to the second comparative example shown in FIG. 4B.

Wiring lines 108h and 108i connected to the connector 107B are drawn out of the connector 107B to the ceramic heater 100 side and are led to pass through the through hole of the end supporting member 104 and to penetrate through the fixing belt 101 along the stay 102 (see FIG. 2).

Edge portions of the wiring lines 108h and 108i are connected to a terminal 110 by passing through outside of the connector 107J on the opposite side.

The connector 107B can be attached to/detached from the ceramic heater 100 by moving to the terminal 110 side within a range of a slack of the wiring lines 108h and 108i.

### Third Embodiment

The present invention may be carried out by other embodiments in which a part or a whole of the configuration of the abovementioned embodiments is replaced with a substitutional configuration as long as the belt member can be drawn out as it is. That is, the invention can be applied also to an image heating apparatus using a dielectric heating-type heating member that requires no connector. This case permits to replace the belt member just by detaching the shift restricting member from the second end supporting member. The configuration of the image heating apparatus having the connector can be replaced with another configuration as long as the belt member can be drawn out while attaching the connector on a draw-out side of the belt member to the heating member.

It is noted that the image heating apparatus includes, beside the fixing apparatus, a surface heating apparatus configured to adjust glossiness and nature of a surface of a semi-fixed or fixed image. The image heating apparatus also includes a curl removing apparatus configured to remove a curl of a recording medium on which a fixed image has been formed. The image heating apparatus may be also carried out as one system or a component unit solely installed and controlled, beside being incorporated into the image forming apparatus. That is, the image heating apparatus may be carried out in any image forming apparatus regardless of types thereof such as monochrome/full-color, sheet-type/recording medium conveying-type, intermediate transfer-type, toner image forming-type, and transfer-type image forming apparatus. The invention may be carried out in any image forming apparatus of various uses such as a printer, various printing machines, a copier, a facsimile machine, a multi-function printer, or the like, by adding a required device, an attachment, and a casing structure.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-228824, filed on Oct. 16, 2012, which is hereby incorporated by reference herein in its entirety.

What is claimed is:

1. An image heating apparatus, comprising:
an endless rotational belt member;
a first end supporting member configured to be non-rotational and to support a first end of the belt member;
a second end supporting member configured to be non-rotational, to support a second end of the belt member, and to be a size permitting to pass through an inside of the belt member;
a heating member having a first electrode portion projecting outside in a rotation axial direction of the belt member from the first end supporting member, and a second electrode portion projecting outside in the rotation axial direction of the belt member from the second end supporting member, the heating member being in contact with an inner surface of the belt member and heating a recording medium through an intermediary of the belt member;
a first connector connected to the first electrode portion;
a second connector connected to the second electrode portion and formed into a size permitting to pass through the inside of the belt member in a condition being connected with the second electrode portion; and
a wiring line wired from the second connector to pass through the second end supporting member and a space of an inner circumferential side of the belt member and to be drawn out of the first end of the belt member.

2. The image heating apparatus according to claim 1, wherein the second connector can be taken out of the second electrode portion in the rotation axial direction of the belt member.

3. The image heating apparatus according to claim 2, wherein the second connector has a through hole that permits the wiring line to pass through in the rotation axial direction of the belt member; and
the through hole holds the wiring line movably in the rotation axial direction of the belt member.

4. The image heating apparatus according to claim 1, further comprising a shift restricting member detachably attached to the second end supporting member and abutting against an edge of the second end of the belt member to restrict a shift movement of the belt member.

5. The image heating apparatus according to claim 2, further comprising a shift restricting member detachably attached to the second end supporting member and abutting against an edge of the second end of the belt member to restrict a shift movement of the belt member.

6. The image heating apparatus according to claim 3, further comprising a shift restricting member detachably attached to the second end supporting member and abutting against an edge of the second end of the belt member to restrict a shift movement of the belt member.

7. The image heating apparatus according to claim 4, wherein the shift restricting member is a plate-like member in which a U-shaped cutaway portion is formed, and the second end supporting member is provided with a groove configured to hold an edge of the U-shaped cutaway portion.

8. The image heating apparatus according to claim 4, wherein the first end supporting member is formed integrally with a shift restricting member abutting against an edge of the first end of the belt member to restrict a shift movement of the belt member.

9. The image heating apparatus according to claim 7, wherein the first end supporting member is formed integrally with a shift restricting member abutting against an edge of the first end of the belt member to restrict a shift movement of the belt member.

10. The image heating apparatus according to claim 1, further comprising:
a guide member supporting the heating member across an entire length in the rotation axial direction of the belt member and guiding the inner surface of the belt member; and
a support member disposed so as to link the first and second end supporting members and to support the guide member by penetrating through the belt member like a beam;
wherein the heating member includes a ceramic substrate on which first and second electrode patterns of the first and second electrode portions and resistant heating pattern connected to the first and second electrode patterns are formed; and
wherein the first and second connectors are configured to detachably secure the heating member to the guide member.

11. The image heating apparatus according to claim 1, further comprising a roll member coming into pressure contact with the heating member through the intermediary of the belt member and forming a nip portion nipping the recording medium;
a drive mechanism that rotationally drive the roll member such that the belt member is rotationally driven.

12. An image heating apparatus, comprising:
an endless rotational belt member;
a first end supporting member configured to be non-rotational and to support a first end of the belt member;
a second end supporting member configured to be non-rotational, to support a second end of the belt member, and to be a size permitting to pass through an inside of the belt member; and
a shift restricting member detachably attached to the second end supporting member and abutting against an edge of the second end of the belt member to restrict a shift movement of the belt member.

13. The image heating apparatus according to claim 12, wherein the shift restricting member is a plate-like member in which a U-shaped cutaway portion is formed, and the second end supporting member is provided with a groove configured to hold an edge of the U-shaped cutaway portion.

14. The image heating apparatus according to claim 12, wherein the first end supporting member is formed integrally with a shift restricting member abutting against an edge of the first end of the belt member to restrict a shift movement of the belt member.

15. The image heating apparatus according to claim 13, wherein the first end supporting member is formed integrally with a shift restricting member abutting against an edge of the belt member on the first end to restrict a shift movement of the belt member.
